(19) United States
(12) Patent Application Publication
(10) Pub. No.: US 2012/0298318 A1
(43) Pub. Date: Nov. 29, 2012

(54) MECHANISM FOR BLOCKING THE ROTATION OF SPRING DRIVEN ROLLER BLINDS

(76) Inventor: Jerzy Wolek, Zarow (PL)

(21) Appl. No.: 13/113,335

(22) Filed: May 23, 2011

(51) Int. Cl. E06B 9/56

(52) U.S. Cl. 160/299

(57) ABSTRACT

A mechanism for blocking the rotation of a roller blind having a winding roller with a spring drive used to block the sunshade in its set position of unwinding, immovably fixed to the holder fir the roller blind holder its winding roller, characterized in that it is built from a sleeve (1) with cams (2a), (2b), (2c), (2d) formed on its inner side and in the sleeve (1) there is located a roller (3) with a guide (4) as an oblong groove, formed above the cams (2a), (2b), (2c), (2d) on its cylindrical side and in the guide there is a ball (5) which during revolution of the roller (3) against the sleeve (1), depending on the direction of that rotation, is moved between the cams (2a), (2b), (2c), (2d) or blocked in a pocket (2e) formed in the cam (2b) in positions from I to IV, blocking or releasing relative revolution of the roller (3) and the sleeve (1). In another embodiment cams (2a), (2b), (2c), (2d) are formed on the roller (3) and the guide (4) is formed on the sleeve (1).

### CROSS REFERENCE TO RELATED APPLICATIONS

Applicant claims priority to his PCT application, PCT/PL2009/00008 filed Sep. 16, 2009 and published Nov. 11, 2010 as International Application WO/2010/12887. PCT/PL2009/00008 claims priority to Polish Patent Application P 387959 filed May 5, 2009.

### BACKGROUND OF THE INVENTION

(1) Field of the Invention

The present invention relates to the field of roller blinds and more particularly to spring driven window blinds.

(2) Description of the Related Art

The subject of this invention is a mechanism for blocking the rotation of a roller blind's winding roller with a spring drive, especially window blinds, used to block the sunshade in its set position of unwinding.

In rolling mechanisms there is often used a spring drive to pull in i.e. to lift and stretch the sunshade in the direction of winding. To keep the sunshade in a desired position of unwinding, blocking mechanisms are used. Exemplary mechanisms blocking the sunshade in a desired position are known from patent specifications No. EP 044134; WO 91/03619 and U.S. Pat. No. 4,534,396. Blocking mechanism is usually embedded into the roller blind's structure. In such designs, after the sunshade has been unrolled from the roller, it is blocked in its lower position.

From patent abstracts No. U.S. Pat. No. 4,372,432 and U.S. Pat. No. 5,375,643 is known a helical spring partly wound round a plastic part. This solution is simpler design-wise than other known solutions although dimensional tolerances of the spring and of the plastic part do not allow achieving a satisfactory design.

### SUMMARY OF THE INVENTION

The present invention is a mechanism for blocking the rotation of a roller blind's winding roller. Such blind are driven with a spring drive. Such blinds are mostly used in window blinds, immovably fixed to a roller blind holder. The winding roller, according to the instant invention is characterized by the fact that it is built from a sleeve with cams formed on its inner side. In the sleeve there is located a roller with a guide as an oblong groove, formed above the cams on its cylindrical side. In the guide there is a ball which during revolution of the roller against the sleeve, depending on the direction of that rotation, is moved between the cams or blocked in a pocket formed in the cam in positions from I to IV, blocking or releasing relative revolution of the roller and the sleeve.

Advantageously on the sleeve there are formed two pairs of cams, of the same shape, offset one against another with 180° on the surface of the sleeve.

Advantageously the sleeve is joined to the winding roller and the roller is joined to roller blind's holder.

Advantageously the sleeve is joined to roller blind's holder and the roller is joined to the winding roller of roller blinds.

Mechanism blocking the rotation of roller blinds winding roller with a spring drive, specially a window blinds, immovably fixed to roller blinds holder and its winding roller, according to a different form of the invention is characterized by the fact, that it is built from a roller with cams formed on its cylindrical side, on which a sleeve is seated, on cylindrical side of that sleeve, above the cams, there is formed a guide as an oblong groove. In the guide there is a ball which during revolution of the roller against the sleeve, depending on the direction of that revolution, is moved between the cams or blocked in a pocket formed in the cam in positions from I to IV, blocking or releasing relative revolution of the roller and the sleeve.

Advantageously on the roller there are formed two pairs of cams, of the same shape, offset one against another with 180° on the surface of the roller.

Advantageously the sleeve is joined to the winding roller and the roller is joined to roller blinds holder.

Advantageously the sleeve is joined to roller blinds holder and the roller is joint to the winding roller of roller blinds.

The advantage of the invention is design-wise simple solution allowing for reliable blocking of winding roller against roller blinds holders in different positions of unrolled sunshade, being wound onto winding roller.

An appreciation of the other aims and objectives of the present invention and an understanding of it may be achieved by referring to the accompanying drawings and description of a preferred embodiment.

### BRIEF DESCRIPTION OF THE DRAWINGS

Examples of embodiments of this invention are shown in the following Figures.

FIG. 1 presents a longitudinal section of the blocking mechanism;

FIG. 2 presents an unfolded view of the sleeve surface with the cams from FIG. 1;

FIG. 3 presents longitudinal section of mechanism in a second embodiment;

FIG. 4 presents an unfolded view of the roller surface with the cams from FIG. 3; and

FIG. 5 presents an unfolded view of the roller surface or of the sleeve surface in another embodiment.

### DETAILED DESCRIPTION OF THE PREFERRED EMBODIMENT

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

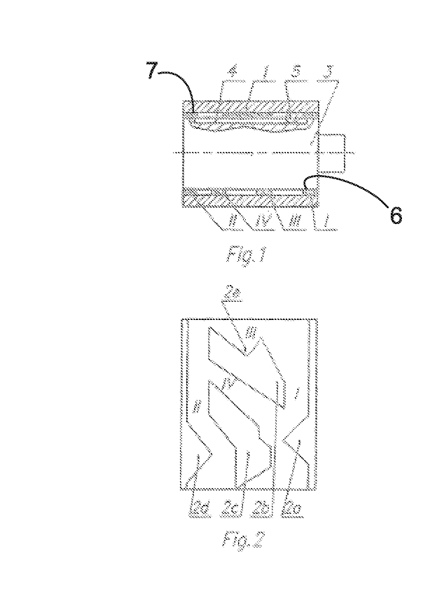

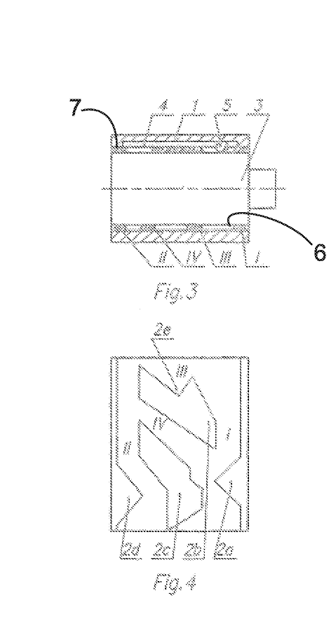

Referring to FIGS. 1 and 2, one embodiment of the blocking mechanism immovably fixed to a roller blind holder and its winding roller, on which the sunshade is wound, consists of a cylindrical sleeve 1 in which cams 2a, 2b, 2c and 2d are formed. The cams are formed on the inner side 7 of the sleeve 1. In the cam 2b there is formed a pocket 2e. A roller 3 is seated in sleeve 1. In the cylindrical outer part 6 of that roller 3 there is formed a guide 4 as an oblong groove. In the guide 4 there is placed a ball 5. The ball 5 during revolution of the roller 3 against the sleeve 1, depending on the direction of that revolution, is blocked in a pocket 2e formed in the cam 2b or moves freely between cams 2a, 2b, 2c, 2d between positions I, II, III, IV marked in FIG. 2.

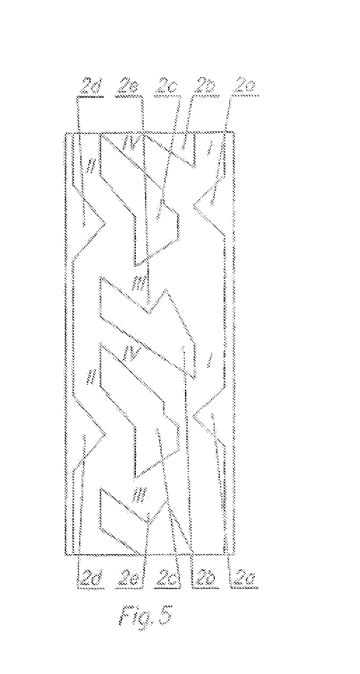

In another embodiment according to the invention shown on FIGS. 3 and 4, the blocking mechanism comprises sleeve 1 in which there is seated a roller 3, however cams 2a, 2b, 2c and 2d as well as a pocket 2e in cam 2b are formed in the cylindrical outer part 6 of the roller 3. Sleeve 1 contains a formed guide 4 as an oblong groove. The guide 4 is formed in the inner side 7 of the sleeve 1. In the guide 4 there is placed a ball 5. The ball 5 during revolution of the roller 3 against the sleeve 1, depending on the direction of that revolution, is blocked in a pocket 2e formed in the cam 2b or moves between cams 2a, 2b, 2c, 2d in positions I5 II, III, IV marked in FIG. 4.

The instant blocking mechanism can be embedded into the construction of roller blinds in two ways. In the first one, roller 3 of the blocking mechanism is immovably fixed to the roller blind holder and sleeve 1 is immovably fixed to winding roller of the roller blind. In the second one it is the other way round, meaning that sleeve 1 is immovably fixed to the roller blind holder and the roller 3 is immovably fixed to the winding roller of the roller blind.

The principle of operation of the invention is identical in both embodiments. In the rest point of roller blinds, meaning the sunshade is entirely wound up on the winding the roller the ball 5 takes position I in guide 4 of roller 3 between cams 2a and 2b. Position I allows for rolling of the sunshade. When the sunshade is unrolled, meaning it is wound up on the winding roller with at least a half-turn, the winding roller ball 5 moves through position IV into position II between cams 2c and 2d. In this position the mechanism allows for unrolling of the sunshade to its desired length. When unrolling ceases, the spring mechanism operates and the direction of revolution of winding of the winding roller and rolling of the sunshade is changed. Ball 5 is moved into position III into pocket 2e of cam 2b. In this position of the ball 5, the mechanism is blocked and the sunshade is stopped at its desired length. To unlock the mechanism and allow for rolling the sunshade all that is needed is to slightly pull the sunshade downwards so that winding roller revolves between ⅕ and ½ of a turn which makes the ball 5 to move into position I between cams 2a and 2c.

If the blocked sunshade is pulled with more than ½ a turn and is then released, then the ball 5 moves through IV and position II into position III and the sunshade in blocked in a new position.

In another embodiment, shown on FIG. 5, the blocking mechanism is built from sleeve 1, roller 3 and guide 4 with a ball 5. However, on the cylindrical part of roller 3 or of sleeve 1 there are formed two pairs of cams 2a, 2b, 2c and 2d, offset one against another with 180°. The principle of operation of the mechanism in this embodiment is analogous to the principles of operation of the embodiments presented above.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A mechanism for blocking the rotation of a roller blind having a winding roller with a spring drive, immovably fixed to a holder for said roller blind and said winding roller, comprising:
a cylindrical sleeve (1) having an inner side (7);
a first set of cams (2a), (2b), (2c), (2d) formed on said inner side (7); a pocket (2e) formed in said cam (2b);
a roller (3) in said sleeve (1) having an outer side (7); said roller(3) having a guide (4) formed as an axial, oblong groove, in said outer side (7) located above said cams (2a), (2b), (2c), (2d); and
a ball (5) bearing against and located between said inner side (7) and said guide (4);
wherein, during rotation of said roller (3) against said sleeve (1), said ball (5) is moved between said cams (2a), (2b), (2c), (2d) or is blocked in said pocket (2e) in positions from I to IV, blocking or releasing relative rotation of said roller (3) and said sleeve (1), depending on the direction of rotation.

2. A mechanism according to claim 1, further comprising on said inner side (7) a second set of cams (2a), (2b), (2c), (2d); said sets of cams being offset 180° from each other.

3. A mechanism according to claim 1, in which said sleeve (1) is joined to said winding roller and said roller (3) is joined to said roller blind holder.

4. A mechanism according to claim 2, in which said sleeve (1) is joined to said winding roller and said roller (3) is joined to said roller blind holder.

5. A mechanism according to claim 1, in which said sleeve (1) is joined to said roller blind holder and said roller (3) is joined to said winding roller.

6. A mechanism according to claim 2, in which said sleeve (1) is joined to said roller blind holder and said roller (3) is joined to said winding roller.

7. A mechanism for blocking the rotation of a roller blind having a winding roller with a spring drive, immovably fixed to a holder for said roller blind and said winding roller, comprising:
a cylindrical roller (3) having an outer side (7);
a first set of cams (2a), (2b), (2c), (2d) formed on said outer side (7); a pocket (2e) formed in said cam (2b);
a sleeve (1) having an inner side (6) on said roller (3); said sleeve (1) having a guide (4) formed as an axial, oblong groove, in said inner side (6) located above said cams (2a), (2b), (2c), (2d); and
a ball (5) bearing against and located between said outer side (7) and said guide (4);
wherein during rotation of said roller (3) against said sleeve (1), said ball (5) is moved between said cams (2a), (2b), (2c), (2d) or blocked in said pocket (2e) in positions from I to IV, blocking or releasing relative rotation of said roller (3) and said sleeve (1), depending on the direction of rotation

8. A mechanism according to claim 5, further comprising a second set of cams (2a), (2b), (2c), (2d) on said outer side (7); said first and second sets of cams being offset from one another by 180°.

9. A mechanism according to claim 7, in which said sleeve (1) is joined to said winding roller and said roller (3) is joined to said roller blind holder.

10. A mechanism according to claim 8, in which said sleeve (1) is joined to said winding roller and said roller (3) is joined to said roller blind holder.

11. A mechanism according to claim 7, in which said sleeve (1) is joined to said roller blind holder and said roller (3) is joined to said winding roller.

12. A mechanism according to claim 8, in which said sleeve (1) is joined to said roller blind holder and said roller (3) is joined to said winding roller.
